(19) United States
(12) Patent Application Publication
(10) Pub. No.: US 2016/0292770 A1
(43) Pub. Date: Oct. 6, 2016

(54) SYSTEM, METHOD, AND APPARATUS FOR REMOTE SIZING AND SHOPPING

(71) Applicant: Mohammad ALSELIMI, N Tonawanda, NY (US)

(72) Inventor: Mohammad ALSELIMI, N Tonawanda, NY (US)

(21) Appl. No.: 14/676,394

(22) Filed: Apr. 1, 2015

(51) Int. Cl. G06Q 30/06; G06Q 50/00

(52) U.S. Cl. CPC G06Q 30/0631; G06Q 30/0643; G06Q 50/01

(57) ABSTRACT

A remote shopping system includes at least one server having circuitry configured to receive body measurements corresponding to dimensions of a body of a user as well as at least one body image of the user. The circuitry also processes the at least one body image of the user to determine additional body measurements, generates a shopper avatar having proportional dimensions to the body measurements, and determines shopper clothing sizes corresponding to one or more size charts. A clothing budget is determined including budget subcategories associated with one or more types of clothing, and style preferences are determined based on style, store, and brand inputs. One or more suggested articles of clothing are output to an external device based on the shopper profile, and one or more clothing selections are received. Shopper feedback is received related to the one or more clothing selections.

### GRANT OF NON-EXCLUSIVE RIGHT

This application was prepared with financial support from the Saudia Arabian Cultural Mission, and in consideration therefore the present inventor has granted, the Kingdom of Saudi Arabia a non-exclusive right to practice the present invention.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Online shopping for clothes has become increasingly popular due to the convenience of shopping from home without having to spend time making trips to the store. One difficulty with online shopping is that it can be difficult to be certain that the articles of clothing purchased online will fit properly and meet the shopper's style preferences.

### SUMMARY

In an exemplary embodiment, a remote shopping system includes at least one server having circuitry configured to receive body measurements corresponding to dimensions of a body of a user as well as at least one body image of the user. The circuitry also processes the at least one body image of the user to determine additional body measurements, generates a shopper avatar having proportional dimensions to the body measurements, and determines shopper clothing sizes corresponding to one or more size charts. A clothing budget is determined including budget subcategories associated with one or more types of clothing, and style preferences are determined based on style, store, and brand inputs. One or more suggested articles of clothing are output to an external device based on the shopper profile, and one or more clothing selections are received. Shopper feedback is received related to the one or more clothing selections.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary illustration of remote shopping system, according to certain embodiments;

FIG. 2 is an exemplary flowchart of a remote shopping process, according to certain embodiments;

FIG. 3 is an exemplary illustration of a shopper avatar screen, according to certain embodiments;

FIG. 4 is an exemplary illustration of a budget warning screen, according to certain embodiments;

FIG. 5 is an exemplary flowchart of a shopper profile generation process, according to certain embodiments;

FIG. 6A is an exemplary illustration of a budget determination screen, according to certain embodiments;

FIG. 6B is an exemplary illustration of a budget category screen, according to certain embodiments;

FIG. 7A is an exemplary illustration of body measurements, according to certain embodiments;

FIG. 7B is an exemplary illustration of a size chart, according to certain embodiments;

FIG. 8 is an exemplary illustration of a shopper body profile, according to certain embodiments;

FIG. 9 is an exemplary illustration of a style selection screen, according to certain embodiments;

FIG. 10 is an exemplary illustration of a social media linking screen, according to certain embodiments;

FIG. 11 is an exemplary illustration of a store and/or brand selection screen, according to certain embodiments;

FIG. 12 is an exemplary flowchart of a clothing selection process, according to certain embodiments;

FIG. 13 is an exemplary flowchart of a shopper feedback process, according to certain embodiments;

FIG. 14 is an exemplary illustration of a shopper feedback screen, according to certain embodiments; and

FIG. 15 illustrates a non-limiting example of a server, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “approximate,” “about,” and similar terms generally refer to ranges that include the identified value within a margin of 20%, 10%, or preferably 5%, and any values therebetween.

Aspects of the disclosure are directed to a system for shopping for apparel, such as clothes, shoes, hats, and the like, from a remote location. A remote shopping apparatus determines shopper profile factors, such as a size, style, and budget of a shopper, and suggests one or more articles of clothing for the shopper to purchase based on the shopper profile factors. The remote shopping apparatus also allows the shopper to view a visual representation of how the one or more articles of clothing will appear when worn by the shopper, which may assist the shopper with making selections and purchases.

Throughout the disclosure, terms referring to the fit of clothing are used. For example, terms such as “fit properly” or “fit well” may refer to articles of clothing that fit a person wearing the clothing as the designer and/or manufacturer intended and may also be comfortable to the person wearing the clothing. In addition, terms describing clothing that does not fit, such as “does not fit properly,” “ill fitting,” “too tight,” or “too loose,” describing clothing that does not fit the person wearing the clothing as the designer and/or manufacturer intended.

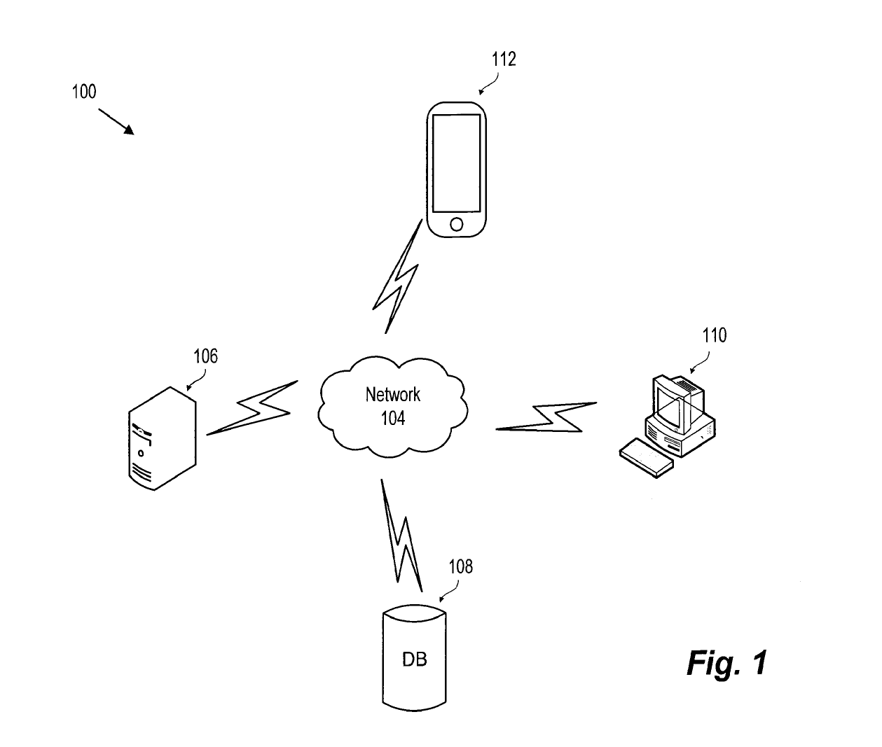

FIG. 1 is an exemplary illustration of remote shopping system 100, according to certain embodiments. The computer 110 represents one or more computers 110 and acts as a client device that is connected to the server 106, the database 108, and the mobile device 112, via the network 104. In some aspects, the computer 110 is also referred to as a remote shopping apparatus, and the terms computer and remote shopping apparatus are used interchangeably throughout the disclosure. In some implementations, the computer 110 is an external device that is used to access an interface with the remote shopping system 100 where users, such as shoppers, can input size, style, and budget information, select articles of clothing to virtually try on and/or purchase, and provide feedback regarding the articles of clothing.

The server 106 represents one or more servers connected to the computer 110, the database 108, and the mobile device 112 via the network 104. In some implementations, the processing circuitry of the server 106 receives shopper profiles that include size, style, and budget preferences of shoppers and processes the data in the shopper profiles to determine one or more articles of clothing to suggest to the shopper to virtually try on. Throughout the disclosure, references to “virtually trying on” articles of clothing means that the shoppers can view selected articles of clothing displayed on a shopper avatar that is developed by the processing circuitry of the server 106 based on measurements of the shopper, uploaded images of the shopper, and the like. Details regarding the generation of the shopper avatar are discussed further herein.

The database 108 represents one or more databases connected to the computer 110, the server 106, and the mobile device 112 via the network 104. In some implementations, shopper profiles are stored in the database 108 and can be accessed by users when accessing the remote shopping system 100 through a login process via an interface at the computer 110 or mobile device 112. The shopper profiles can include budget, size, and style preferences of the users as well as learned preferences determined through a shopper feedback process. Details regarding shopper profiles and shopper feedback process are discussed further herein.

The mobile device 112 represents one or more mobile devices connected to the computer 110, the server 106, and the database 108 via the network 104. The network 104 represents one or more networks, such as the Internet, connecting the computer 110, the server 106, the database 108, and the mobile device 112. The network 104 can also include wireless networks such as WI-FI, BLUETOOTH, cellular networks including EDGE, 3G and 4G wireless cellular systems, or any other wireless form of communication that is known.

As would be understood by one of ordinary skill in the art, based on the teachings herein, the mobile device 112 or any other external device could also be used in the same manner as the computer 110 to input shopper profile information and/or feedback to the remote shopping system 100. For example, users can access shopper profiles, provide feedback regarding recent purchases, and virtually try on articles of clothing via an application on the mobile device 112.

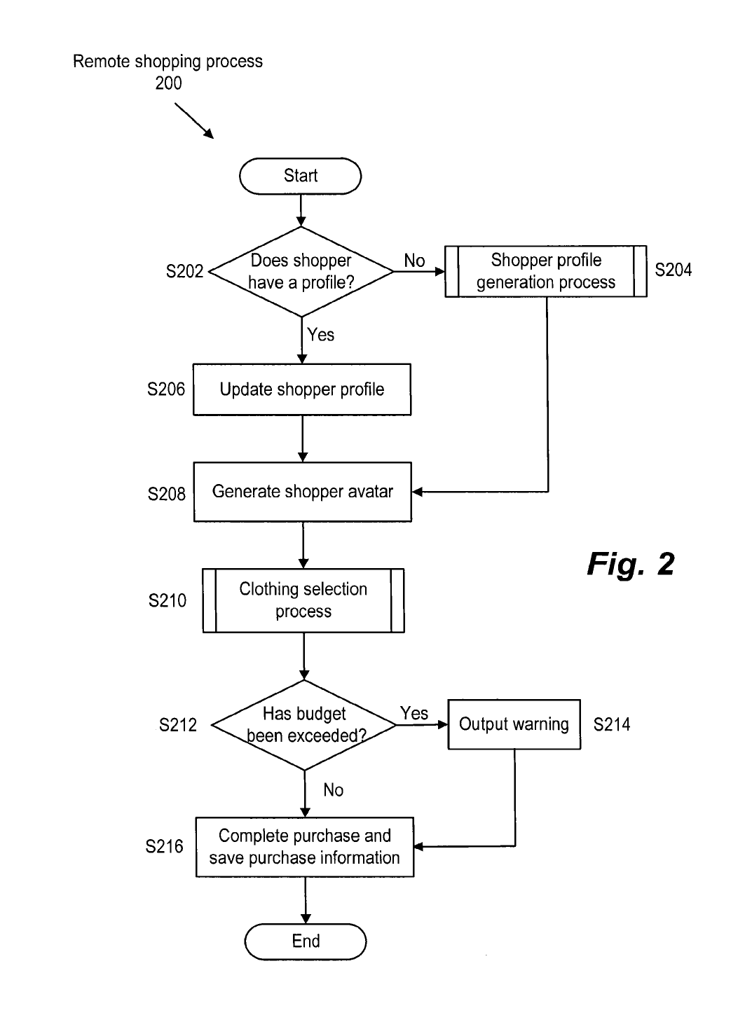

FIG. 2 is an exemplary flowchart of a remote shopping process 200, according to certain embodiments. At step S202, it is determined whether or not a user, such as a shopper, has a shopper profile stored in the database 108. In some implementations, shoppers can access a user account for the remote shopping system 100 by logging in with a username, password, and/or other personal identification information. The processing circuitry of the server 106 searches the database 108 for the shopper profile associated with the personal identification information of the shopper. If it is determined that the shopper has a profile stored in the database 108, resulting in a “yes” at step S202, then step S204 is performed. Otherwise, if it is determined that the shopper does not have a profile stored in the database 108, resulting in a “no” at step S202, then step S204 is performed.

At step S204, a shopper profile generation process is performed. In some implementations, the shopper inputs information at the computer 110 or mobile device 112 related to one or more preferences regarding budget, clothing style, and the like. In addition, the shopper can also input size information by uploading one or more images of the body of the shopper along with one or more body measurements. Based on the budget, style, and size information provided the shopper, the processing circuitry of the server 106 can generate the shopper profile which is stored in the database 108 and can be accessed by the server 106 during future iterations of the remote shopping process 200. Details regarding the shopper profile generation process are discussed further herein.

At step S206, the shopper profile is updated based on additional information provided by the shopper and/or feedback received. In some implementations, the processing circuitry of the server 106 applies one or more machine learning techniques based on previous clothing selections made by the shopper as well as feedback provided by the shopper regarding the previous clothing suggestions. For example, if the shopper has shown patterns of purchases clothing that are sized larger than the size of the shopper in the shopper profile, the processing circuitry of the server 106 can increase the size of the shopper in the shopper profile. Details regarding a shopper feedback process are discussed further herein. In addition, the shopper can provide updated body measurements and modify style and budget preferences via the interface at an external device, such as the computer 110 or mobile device 112.

At step S208, a shopper avatar is generated based on the shopper profile. In some implementations, the shopper avatar is displayed on a screen of an external device as a three-dimensional representation of the body of the shopper generated by the processing circuitry of the server 106. For example, based on the body measurements and images of the shopper, the processing circuitry displays a model of the shopper's body on the screen, which can also incorporate features of the shopper, such as hair color, skin tone, facial structure, and the like.

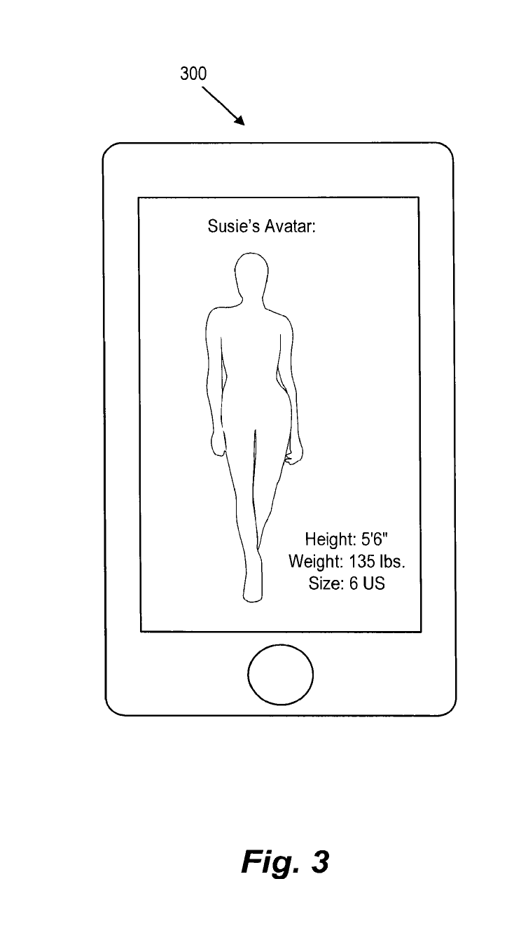

FIG. 3 is an exemplary illustration of a shopper avatar screen 300, according to certain embodiments. The shopper avatar screen 300 displays the three-dimensional representation of the body of the shopper as well as additional size information about the shopper, such as the shopper's height, weight, clothing size, and the like. At the shopper avatar screen 300, the shopper can also update the features of the shopper avatar, such as hair and eye color.

Referring back to FIG. 2, at step S210, a clothing selection process is performed. According to certain embodiments, the processing circuitry of the server 106 performs a web crawling process to identify one or more articles of clothing for the shopper to virtually try on based on budget, style, and size preferences delineated in the shopper profile. The shopper can also manually search clothing retail websites via an interface for the remote shopping system 100 to identify articles of clothing to virtually try on. The selected articles of clothing are virtually tried on by displaying the articles of clothing on the shopper avatar. The shopper can then make decisions regarding whether to purchase the articles of clothing based on how the articles of clothing look on the shopper avatar. Details regarding the clothing selection process are discussed further herein.

At step S212, the processing circuitry of the server 106 determines whether costs of the items selected for purchase during the clothing selection process have exceeded one or more of the budget categories from the shopper profile. If it is determined that one or more of the budget categories has been exceeded during the clothing selection process of step S210, resulting in a “yes” at step S212, then step S214 is performed. Otherwise, if it is determined that the one or more budget categories from the budget profile have not been exceeded, resulting in a “no” at step S212, then step S216 is performed. Details regarding the one or more budget categories are discussed further herein.

At step S214, a warning is output to the shopper if it is determined at step S212 that the costs of the selected clothing items exceed one or more of the budget categories. The warning allows the shopper to reevaluate the decision to purchase the articles of clothing that exceed one or more of the budget categories specified in the shopper profile.

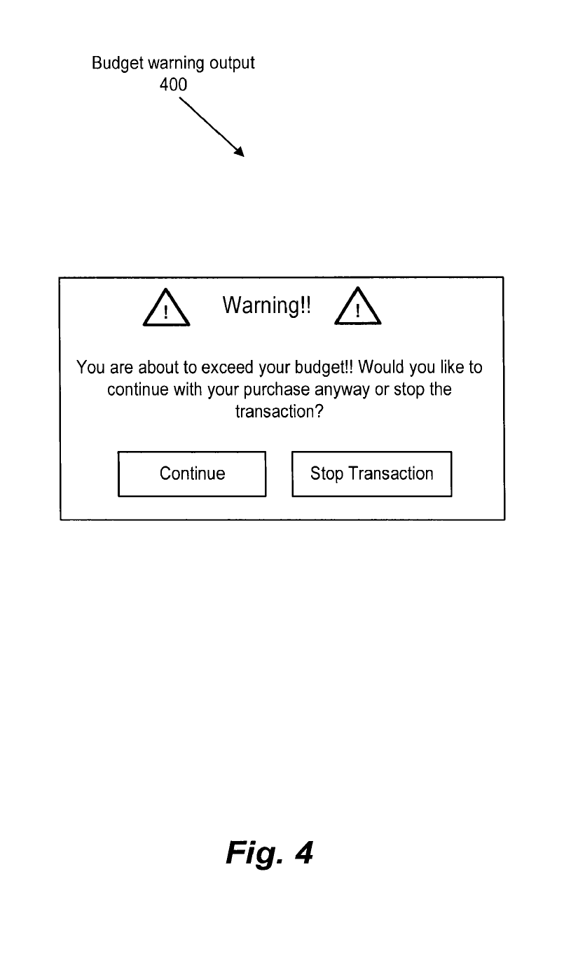

FIG. 4 is an exemplary illustration of a budget warning screen 400, according to certain embodiments. In this example, at the budget warning screen 400, the shopper is notified that he or she is about to exceed one or more of the budget categories specified in the shopper profile. The shopper can select at the interface whether or not the shopper wishes to continue with purchasing the selected articles of clothing. If the shopper selects “continue,” indicating that the shopper wishes to continue purchasing the selected articles of clothing, the process continues to step S206. However, if the shopper selects “stop transaction,” indicating that the shopper does not want to continue, the remote shopping process 200 is terminated. In some implementations, if the shopper selects “stop transaction,” the processing circuitry returns to the clothing selection process of step S210, and the shopper can identify one or more articles of clothing that fall within the one or more budget categories.

Referring back to FIG. 2, at step S216, one or more steps to purchase the selected clothing items are completed, and purchase information is associated with the shopper profile and saved in the database 108. For example, the purchase information includes the link to the article of clothing as well as the cost, size, and style of the clothing. In some implementations, the processing circuitry of the server 106 also obtains a screen shot of the webpage describing the article of clothing, which is also saved in the database 108.

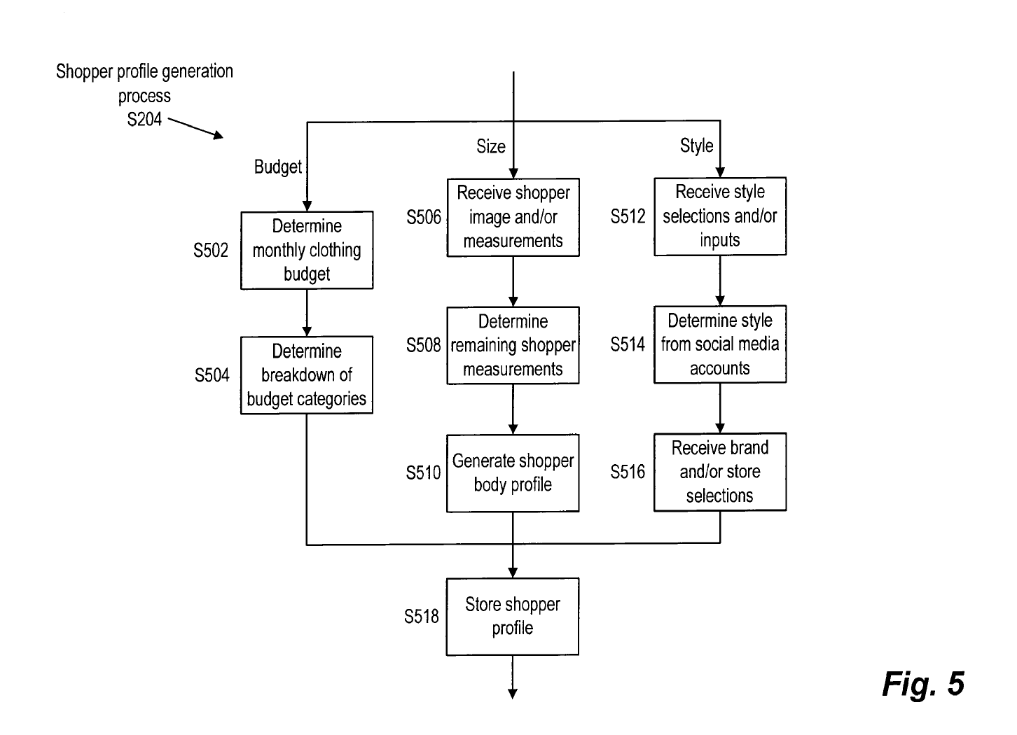

FIG. 5 is an exemplary flowchart of the shopper profile generation process of step S204, according to certain embodiments. The shopper profile includes one or more categories such as the budget, size, and style of the shopper, as well as any other categories related to how a shopper makes decisions on what items of clothing to purchase. In some implementations, the processing circuitry of the server 106 determines the shopper profile based on all of the available categories, but in other implementations, the shopper profile can be generated based on one or some of the available categories. For example, the shopper profile may be based on just the size and budget of the shopper, and the style category may not be included.

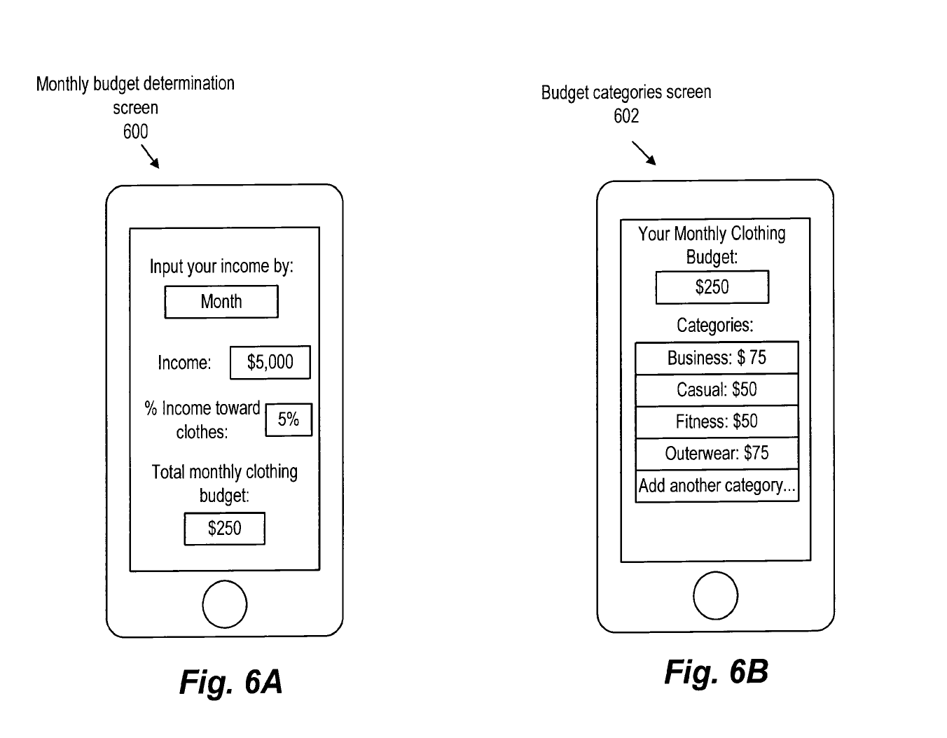

Regarding the budget category of the shopper profile, at step S502, the processing circuitry of the server 106 determines a total clothing budget for the shopper. The budget can be based on one or more time periods, such as a week, month, season, year, and the like. In some implementations, the shopper manually inputs a total monthly clothing budget via the interface at the computer and/or mobile device 112. Alternatively, the processing circuitry can determine total clothing budget based on a percentage of the shopper's income. FIG. 6A is an exemplary illustration of a budget determination screen 600, according to certain embodiments. The budget determination screen 600 illustrates a shopper income input field where the shopper can input his or her total income over a time period, such as a month, year, week, and the like. The budget determination screen 600 also includes a field where the shopper can input a percentage of his or her income to devote to clothes shopping.

Referring back to FIG. 5, at step S504, one or more budget subcategories are determined based on the total clothing budget determined at step S502. In addition, an amount of money is associated with each budget subcategory such that the amount of money for each budget subcategory is less than or equal to the total clothing budget determined at step S502. In some implementations, the user can select from one or more predetermined subcategories, such as business attire, casualwear, formal attire, fitness attire, and the like. Users can also add input additional customized subcategories via an interface at the computer 110 or mobile device. The processing circuitry 106 of the server can also determine one or more budget subcategories to suggest to the shopper based on a time of year, such as the season. For example, during the spring and summer months, the budget subcategory of “swimwear” may be suggested, while during the fall and winter months, the budget subcategory of “outerwear” may be suggested.

FIG. 6B is an exemplary illustration of a budget category screen 602, according to certain embodiments. The budget category screen 602 includes the total monthly budget along with the one or more budget subcategories and the amount of money allocated to each budget subcategory. In some implementations, the budget subcategories include one or more clothing types, such as casual, fitness, business, outerwear, and other subcategories. In some implementations, the processing circuitry of the server 106 determines default amounts of money for each budget subcategory. For example, the processing circuitry of the server 106 may assign equal amounts of money to each budget subcategory, and the shopper can modify the values as desired while remaining within the total monthly budget. The budget information received and/or determined at steps S502 and S504 make up the budget category of the shopper profile.

Referring back to FIG. 5, regarding the size category of the shopper profile, at step S506, the server 106 receives one or more images of the body of the shopper and one or more associated measurements of the shopper. In some implementations, one or more images of the shopper are uploaded to the server 106 via an interface at the computer 110 or mobile device 112. For example, the shopper can take full-length images of the front and back of the body with the installed digital camera on the mobile device 112 and upload the obtained images via an application at the mobile device 112. The shopper can also provide one or more additional body measurements, such as height, waist measurement, hip measurement, or any other body measurement. In some implementations, the processing circuitry of the server 106 pre-processes the uploaded body images to determine that the image quality is greater than a predetermined threshold and that the image processing software can distinguish the body in the image through one or more image processing algorithms that may include an edge detection algorithm.

At step S508, the processing circuitry of the server 106 determines one or more remaining dimensions for the body of the shopper. Based on the one or more images of the body of the shopper uploaded to the server 106 and the one or more body measurements provided by the shopper, the processing circuitry of the server 106 interpolates one or more remaining body measurements that may factor into one or more clothing size determinations for the shopper. For example, the processing circuitry can determine relative distances between edges in the one or more body images to determine the proportions of the body of the shopper.

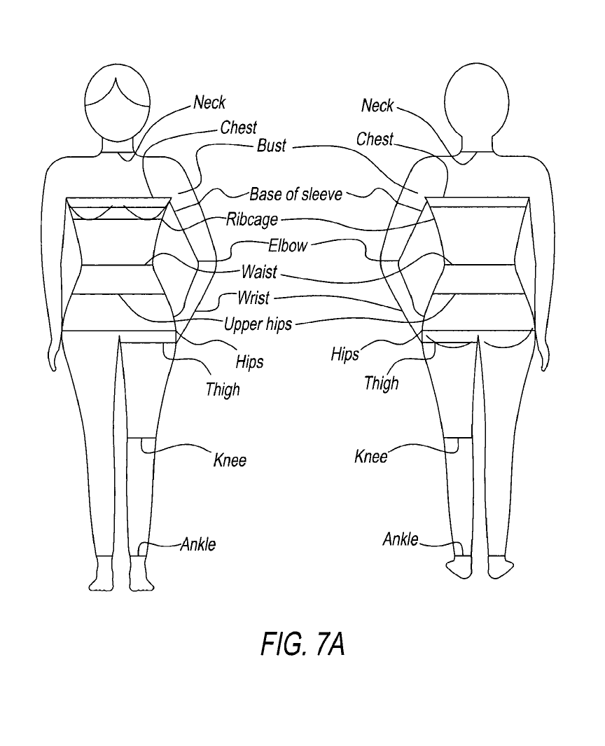

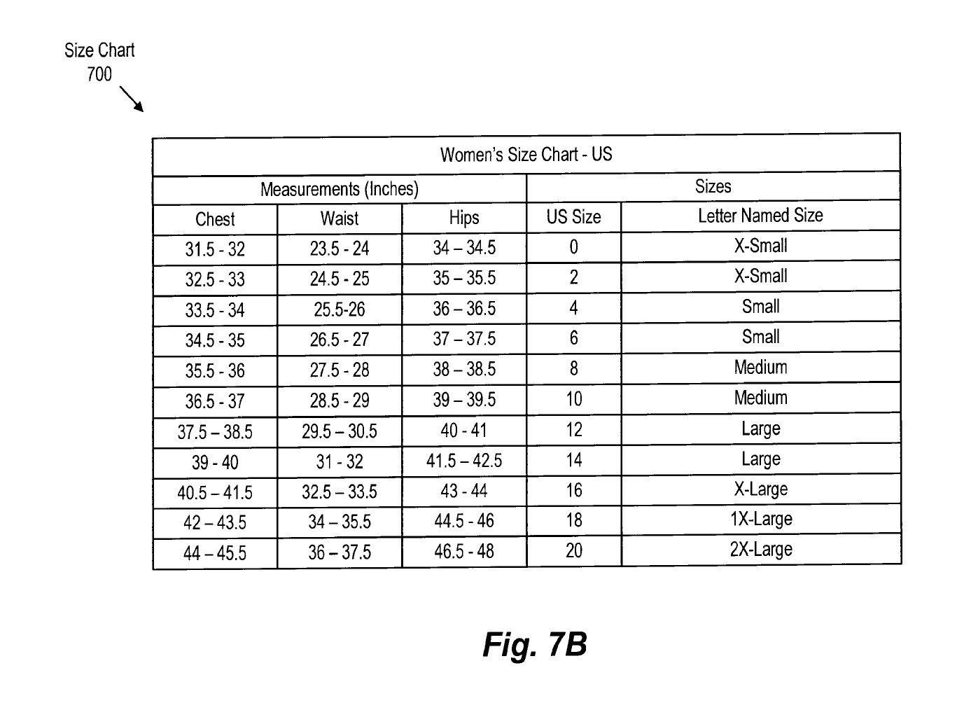

FIG. 7A is an exemplary illustration of additional body measurement locations, according to certain embodiments. In FIG. 7A, the one or more body measurement locations for females are illustrated. The body measurement locations for females may include or exclude other locations than those shown. In addition, body measurement locations for males may include other locations than those discussed with respect to FIG. 7A. The one or more additional body measurement locations that may be determined by the processing circuitry of the server 106 include the neck, chest, bust, base of sleeve, ribcage, elbow, wrist, waist, upper hips, hips, thigh, knee, and ankle. For example, when determining shirt size of the shopper, the processing circuitry of the server 106 may use the body measurements of the neck, chest, bust, base of sleeve, ribcage, elbow, wrist, and/or waist.

Referring back to FIG. 5, at step S510, the processing circuitry of the server 106 generates a shopper body profile based on the one or more body measurements of the shopper. In some implementations, the shopper body profile includes one or more clothing sizes associated with the body measurements of the shopper. For example, an exemplary shopper body profile for a female may include dress sizes, shirt sizes, skirt sizes, and/or pants sizes for the shopper.

FIG. 7B is an exemplary illustration of a size chart 700, according to certain embodiments. The size chart 700 illustrates United States female sizes based on chest, waist, and/or hip measurements. The sizes of the size chart 700 include numbered sizes ranging from size zero to size twenty as well as letter-named sizes from X-Small to 2X-Large. The body measurements and corresponding sizes illustrated by the size chart 700 are merely exemplary and may include greater or fewer sizes and different body measurements. For example, different brands and/or stores may have different size charts that include unequal body measurements for the corresponding sizes, greater or fewer numbers of sizes, and the like.

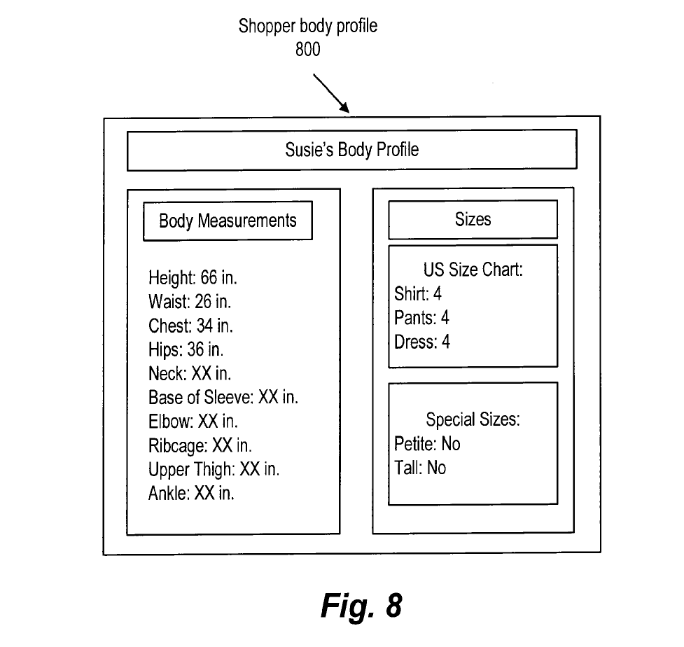

FIG. 8 is an exemplary illustration of a shopper body profile 800, according to certain embodiments. The shopper body profile includes the one or more body measurements input by the shopper at step S506 as well as the additional body measurements determined by the processing circuitry of the server at step S508. The shopper body profile 800 also includes one or more clothing sizes of the shopper, such as the shirt, dress, and/or pants sizes. The shopper body profile 800 can include clothing sizes based one or more size charts for one or more countries, brands, and/or stores. In addition, the shopper body profile 800 can include one or more special size types associated with the shopper. For example, petite and tall size types can be selected for female shoppers who are taller or shorter than an average female. The size information received and/or determined at steps S506 and S508, and S510 make up the size category of the shopper profile.

Referring back to FIG. 5, regarding the style category of the shopper profile, at step S512, the server 106 receives one or more style selections and/or inputs made by the shopper at an interface at the computer 110 or via an application on the mobile device 112. In some implementations, the processing circuitry of the server 106 determines styles for articles of clothing based on brand, store, type of garment, and the like. The processing circuitry also determines one or more clothing selections for the shopper to virtually try on the shopper avatar based on the one or more style selections and/or inputs.

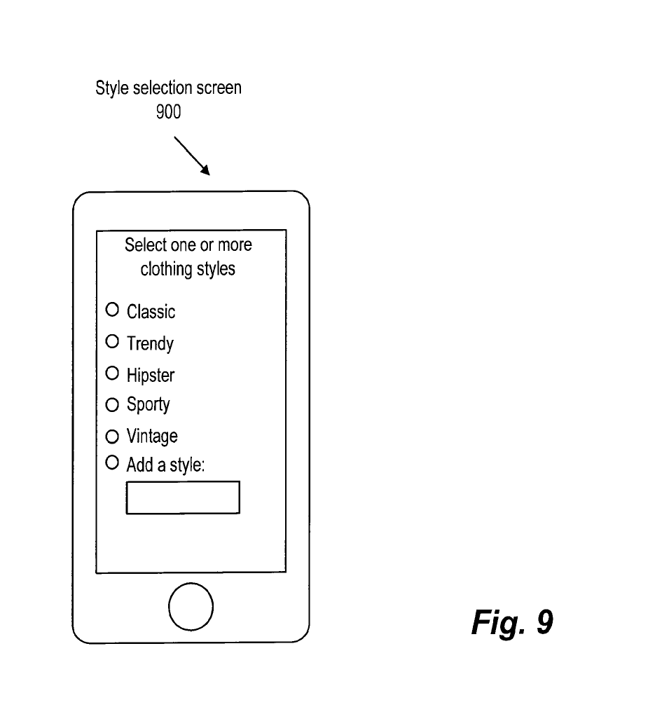

FIG. 9 is an exemplary illustration of a style selection screen 900, according to certain embodiments. The style selection screen 900 includes one or more styles for the shopper to select, such as classic, trendy, hipster, sporty, vintage, and any other type of clothing style. The style selection screen 900 also allows the shopper to input one or more additional types of styles via the external device.

Referring back to FIG. 5, at step S514, the processing circuitry of the server 106 determines one or more styles for the shopper based on style data in one or more social media accounts. Social media platforms, such as PINTEREST, FACEBOOK, TWITTER, and the like, allow users to share information, such as photos and/or website links that can be used by the processing circuitry of the server 106 to determine the one or more styles for the shopper. For example, the shopper can link one or more social media accounts to the shopper profile, and the processing circuitry determines when information related to clothing styles is shared by the shopper on the one or more social media accounts. The information related to clothing styles is harvested by the processing circuitry and is associated with the shopper profile.

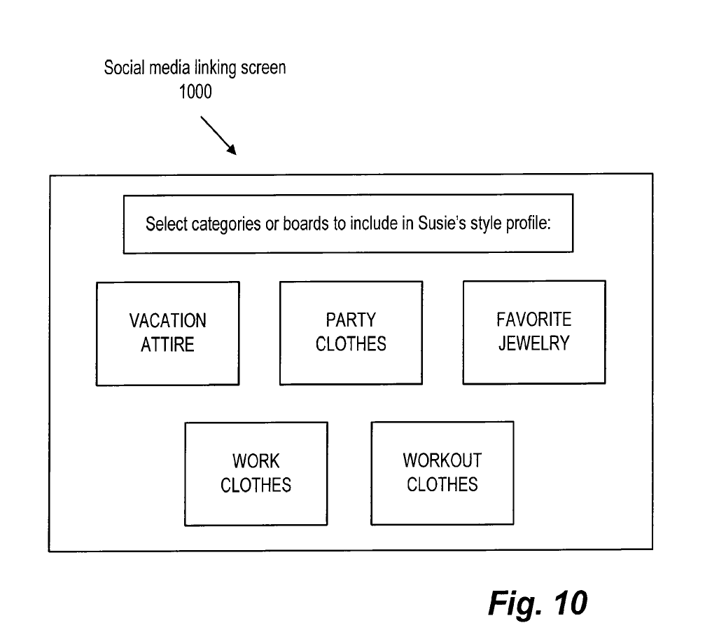

FIG. 10 is an exemplary illustration of a social media linking screen 1000, according to certain embodiments. The social media linking screen 1000 can be associated with at least one social media platform, such as PINTEREST that allows users to categorize web links, photos, images, videos, and the like. For example, in the social media linking screen 1000, the shopper can select one or more style categories of vacation attire, party clothes, favorite jewelry, work clothes, and workout attire to include in the shopper profile. The shopper associates web content, such as the web links, photos, images, and/or videos with each of the style categories. The processing circuitry of the server 106 accesses the web content associated with the style categories to develop the one or more styles for the shopper profile.

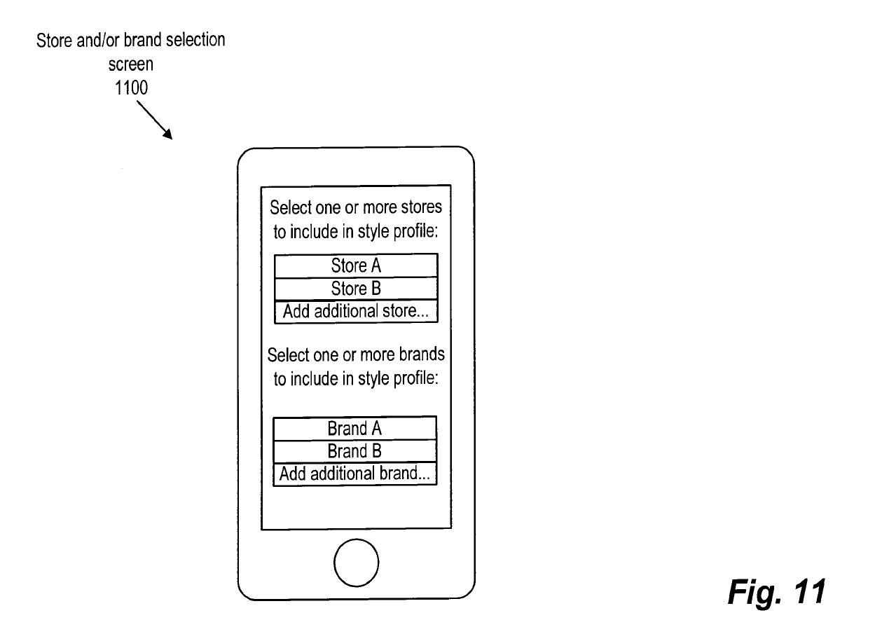

Referring back to FIG. 5, at step 516, the server 106 receives one or more brand and/or store selections made by the shopper at an interface at the computer 110 or via an application on the mobile device 112. The processing circuitry of the server 106 then uses the one or more brands and/or stores selected by the shopper via the external device to develop the one or more styles for the shopper profile. FIG. 11 is an exemplary illustration of a store and/or brand selection screen 1100, according to certain embodiments. The store and/or brand selection screen 1100 includes one or more stores and/or brands for the shopper to select. The store and/or brand selection screen 1100 also allows the shopper to input one or more additional stores and/or brands via the external device. In some implementations, the store and/or brand selection screen 1100 also allows the shopper to provide web links to the stores and/or brands.

Referring back to FIG. 5, at step S518, the information received and/or determined during the shopper profile generation process of step S204 is stored in the database 108. The processing circuitry of the server 106 accesses the information associated with the shopper profile to determine one or more articles of clothing for the shopper to virtually try on during the clothing selection process of step S210, as will be discussed further herein.

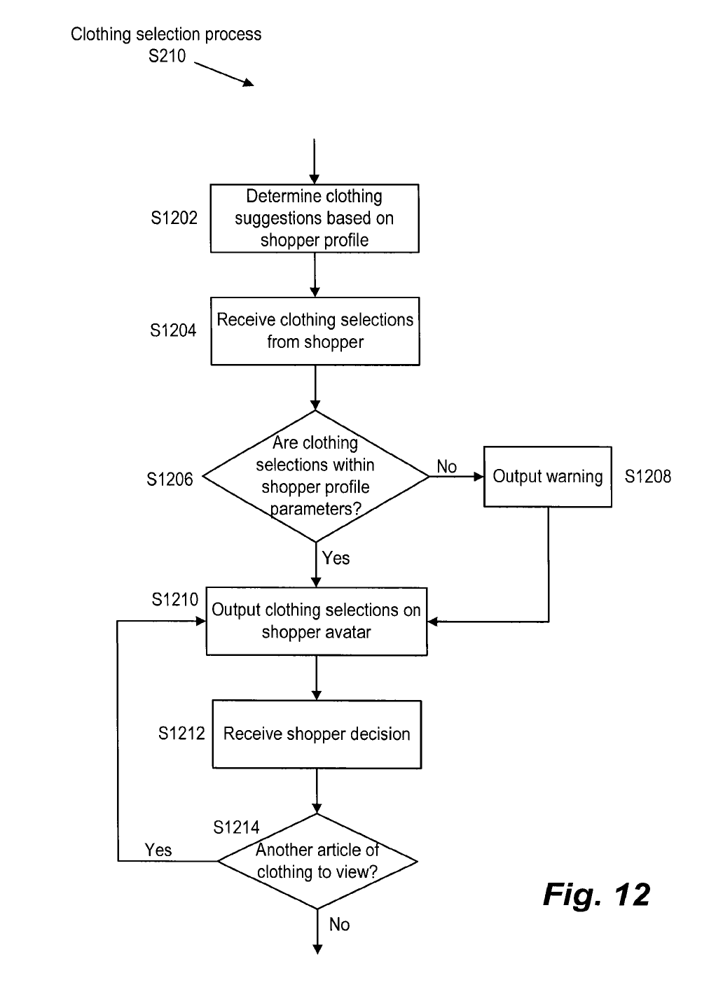

FIG. 12 is an exemplary flowchart of the clothing selection process of step S210, according to certain embodiments. At step S1202, the processing circuitry of the server 106 determines one or more articles of clothing to suggest to the shopper to virtually try on based on the shopper profile. As discussed previously, the shopper profile includes budget, style, and/or size categories that are used by the processing circuitry to determine the articles of clothing to virtually try on. In some implementations, the processing circuitry of the server 106 performs a web crawling process to find the one or more articles of clothing that fit within the budget, style, and size criteria delineated in the shopper profile. For example, the processing circuitry may search websites associated with the brands and/or stores indicated at the store and/or brand selection screen 1100 to find the one or more articles of clothing to suggest to the shopper. The processing circuitry also determines if the suggested articles of clothing are available in stores in sizes that correspond to the shopper body profile.

In addition, the processing circuitry of the server 106 can also determine one or more outfits to suggest to the shopper to virtually try on by grouping articles of clothing, accessories, shoes, and the like, that the shopper may want to wear simultaneously. For example, the processing circuitry may suggest an outfit of a button down shirt, a pencil skirt, high heeled pumps, and earrings to the shopper who is looking for an outfit of business attire.

At step S1204, the processing circuitry of the server 106 receives one or more clothing selections from the shopper via an interface at the computer 110 and/or via an application on a mobile device 112. In some implementations, the shopper selects from the articles of clothing suggested to the shopper at step S1202. The shopper can also perform a manual internet search via the external device to select additional articles of clothing to virtually try on. The one or more clothing selections are saved in the database 108 and are associated with the shopper profile. In some implementations, the one or more clothing selections are saved in a shopping queue or virtual shopping cart, and the shopper can view images and/or descriptions of the clothing selections in the shopping queue.

At step S1206, a determination is made whether the one or more clothing selections from step S1204 are within one or more shopping parameters specified by the shopper profile. In some implementations, the one or more shopping parameters include the budget, style, and size determinations made by the processing circuitry of the server 106 during the shopper profile generation process of step S204. For example, the processing circuitry of the server 106 can compare the sizes of the articles of clothing to the shopper body profile determined at step S510 of the shopper profile generation process of step S204. In addition, the processing circuitry can compare the styles and costs of the selected articles of clothing to the styles and budget determined during the shopper profile generation process of step S204. If it is determined that the one or more clothing selections are within the one or more shopping parameters, resulting in a “yes” at step S1206, then step S1210 is performed. Otherwise, if it is determined that the one or more clothing selections are not within the one or more shopping parameters, resulting in a “no” at step S1206, then step S1208 is performed.

At step S1208, a warning is output to the computer 110 and/or mobile device 112 if it is determined at step S1206 that the one or more clothing selections arc not within the one or more shopping parameters. For example, if the shopper selects an article of clothing in a size 8 when the body profile of the shopper indicates that the shopper should select a size 4, then the shopper is notified that the article of clothing about to be purchased may be too big. The warning can be issued to the shopper via the interface on the computer 110 or mobile device 112. In addition, the processing circuitry outputs a warning if the style of the selected article of clothing does not match the one or more style preferences in the shopper profile.

At step S1210, the processing circuitry of the server 106 outputs at least one of the clothing selections displayed on the shopper avatar, which can give the shopper the ability to see what the clothing selections would look like on the body of the shopper. In some implementations, the shopper can virtually try on one or more articles of clothing by selecting the articles of clothing to be displayed on the shopper avatar. In addition, based on the shopper body profile determined at step S510, the processing circuitry can determine one or more locations on the body of the shopper where the articles of clothing may not fit properly. For example, if the shopper is purchasing a pair of pants with an inseam that is long based on the height of the shopper, the processing circuitry of the server 106 highlight the lower edge of the pants that have been virtually tried on the shopper avatar to indicate that the pants the shopper has selected may be too long for the shopper.

In addition, the processing circuitry can output messages via email and/or text message to the external device of the shopper to notify the shopper of sales, promotions, and/or new arrivals at one or more stores that are associated with the budget, style, and/or size preferences of the shopper profile. The messages output to the external device can include one or more promoted articles of clothing displayed on the shopper avatar.

At step S1212, the processing circuitry of the server 106 receives a decision from the shopper regarding whether or not the shopper wishes to purchase the articles of clothing that have been displayed on the shopper avatar. For example, if a shirt and pants are displayed on the shopper avatar, the shopper may select the shirt for purchase but may indicate that he or she does not wish to purchase the pants.

At step S1214, it is determined whether or not there are any remaining articles of clothing in the shopping queue to display on the shopper avatar. If it is determined that there are one or more remaining articles of clothing in the shopping queue to display on the shopping avatar, resulting in a “yes” at step S1214, then the clothing selection process of step S210 returns to step S1210, and one or more articles of clothing are output on the shopper avatar. Otherwise, if it is determined that there are no more remaining articles of clothing in the shopping queue to display on the shopping avatar, resulting in a “no” at step S1214, then the clothing selection process of step S210 is terminated.

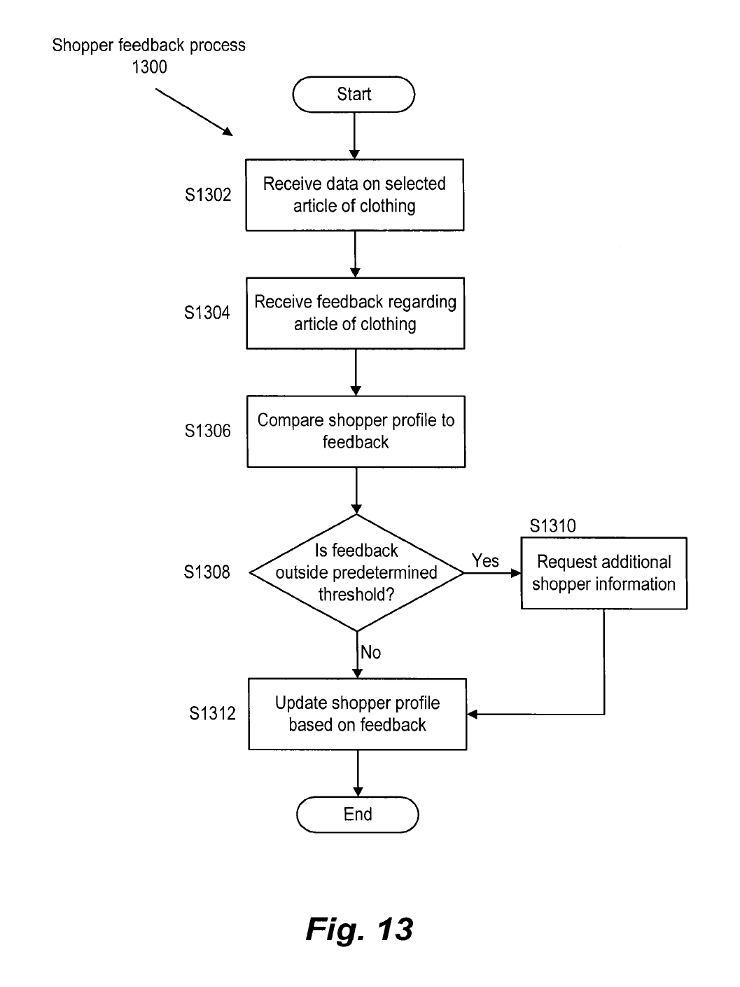

FIG. 13 is an exemplary flowchart of a shopper feedback process 1300, according to certain embodiments. Shoppers can provide feedback regarding clothing selections and/or purchases made during the remote shopping process 200. In some examples, once the shopper physically receives the one or more articles of clothing, the shopper can provide feedback regarding how the article of clothing fits, whether the shopper prefers the style of the articles of clothing, and the like. The processing circuitry then updates the shopper profile based on the received feedback.

At step S1302, the processing circuitry of the server 106 receives data regarding one or more articles of clothing for which the shopper is providing feedback. The shopper selects, via the external device, one or more of the previously purchased articles of clothing for which the shopper wishes to provide feedback. In some implementations, the processing circuitry of the server 106 accesses the purchase information saved in the database 108 at step S216 of the remote shopping process 200. The purchase information related to previously purchased articles of clothing includes the internet links to the articles of clothing as well as the costs, sizes, and styles of the clothing.

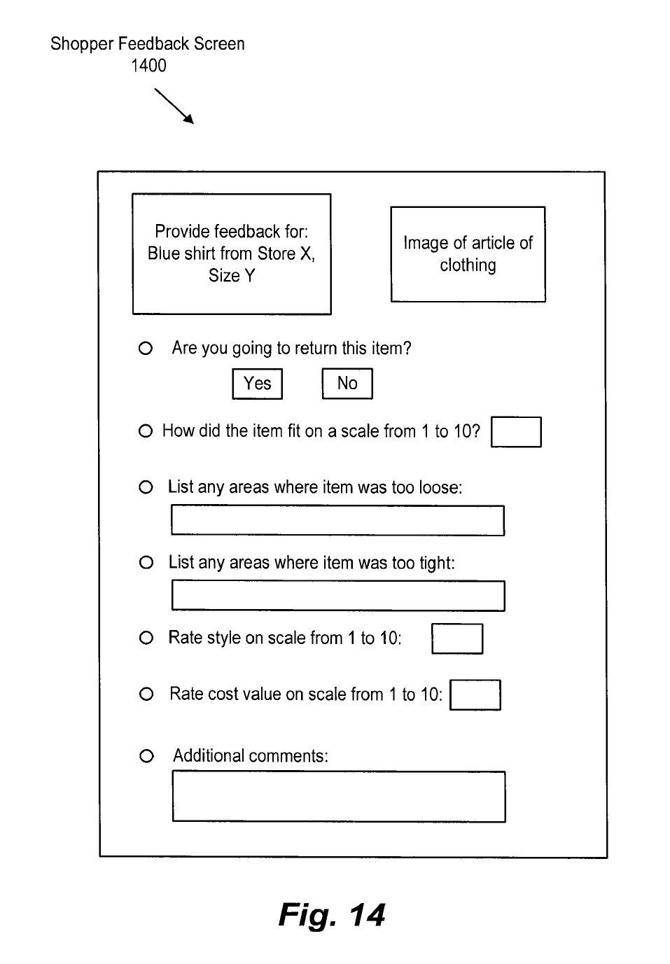

At step S1304, the processing circuitry of the server 106 receives feedback from the shopper regarding the one or more articles of clothing for which the shopper is providing feedback. FIG. 14 is an exemplary illustration of a shopper feedback screen 1400, according to certain embodiments. The shopper feedback screen 1400 is displayed to the shopper via an external device, such as the computer 110 and/or mobile device 112, and includes a picture and/or description of the article of clothing for which the shopper is providing feedback. In some implementations, the shopper feedback screen 1400 includes one or more questions that allow the shopper to express how satisfied the shopper is with the articles of clothing.

For example, the shopper feedback screen 1400 includes a question that asks the shopper if he or she intends to return the article of clothing. If the shopper selects “no,” indicating that the shopper intends to keep the article of clothing, then the processing circuitry determines that the shopper is satisfied with the article of clothing. If the shopper selects “yes,” indicating that the shopper intends to return the article of clothing, then the processing circuitry determines that the shopper is not satisfied with the article of clothing. In addition, the shopper may be asked to rate the fit of the article of clothing on scale of one to ten, with a rating of one indicating a lowest amount of satisfaction with the size and/or fit of the clothing and a rating of ten indicating a highest amount of satisfaction with the size and/or fit of the clothing. The shopper can also be asked to provide details related to specific parts of the body where the article of clothing fit too tightly or too loosely.

The feedback ratings are not limited to ratings on scales from one to ten. Other rating scales may be used, such as percentage of maximum satisfaction, qualitative descriptions, or any other type of rating system.

In addition, the shopper feedback screen 1400 can also ask the shopper to rate the style of the article of clothing on a scale of one to ten, with a rating of one indicating a least amount of satisfaction with the style and a rating of ten indicating a highest amount of satisfaction with the style. The shopper feedback screen 1400 can also ask the shopper to rate the cost of the article of clothing with respect to the one or more budget categories on a scale of one to ten, with a rating of one indicating that the shopper believes the article of clothing has a lowest amount of value relative to the cost and a rating of ten indicating that the shopper believes the article of clothing has a highest amount of value relative to the cost. In some implementations, the shopper feedback screen 1400 also includes an input field for the shopper to add additional comments regarding the article of clothing.

Referring back to FIG. 13, at step S1306, the feedback provided at the shopper feedback screen 1400 is compared to the budget, style, and/or size parameters of the shopper profile. For example, the shopper may provide feedback for a pair pants of size 8 while the processing circuitry of the server 106 may have determined based on the body measurements of the shopper that pants of size 4 may be a best-fitting size for the shopper. Therefore, there is a two size difference between the pants of size 8 and the pants of size 4. In addition, the cost of the article of clothing for which shopper is providing feedback is compared to the one or more budget categories, and the style of the article of clothing is compared to the one or more styles selected by the shopper and/or determined by the processing circuitry of the server 106.

At step S1308, it is determined whether the feedback provided by the shopper is outside a predetermined threshold. In one implementation, the clothing size threshold may be set to within one size of the size determined for the shopper body profile of step S506 of the shopper profile generation process of step S204. For example, the shopper may indicate that he or she does not intend to return the pants of size 8 and also indicates a high amount of satisfaction with the size, style, and cost of the pants with a rating of greater than five on a scale of one to ten. However, the shopper body profile determined at step S510 of the shopper profile generation process of step S204 indicates that the shopper wears a pants size 4, which means that the feedback provided by the shopper is outside the predetermined threshold due to the two-size difference between the purchased pants size and the pants size from the shopper body profile.

Predetermined thresholds can also be established for the budget and style categories of the shopper profile. In addition, style, budget, and size ratings of less than five on a scale of one to ten for any article of clothing can be outside the satisfaction threshold, resulting in a “yes” at step S1308. If the feedback provided by the shopper is outside the predetermined threshold, resulting in a “yes” at step S1308, then step S1310 is performed. Otherwise, if the feedback provided by the shopper is within the predetermined threshold, resulting in a “no” at step S1308, then step S1312 is performed.

At step S1310, if the feedback provided by the shopper is outside the predetermined threshold, then the processing circuitry of the server 106 outputs one or more requests for additional information via an interface at the computer 110 and/or application on the mobile device 112. For example, if the shopper indicates a low amount of satisfaction with the size and/or fit of a dress in a size corresponding to the body measurements in the shopper profile, the processing circuitry may request that the shopper provide updated body measurements and/or an updated image of the body in order to determine an accurate representation of the body of the shopper.

At step S1312, the processing circuitry of the server 106 updates the shopper profile based on the feedback received at step S1304 and/or the additional information received at step S1310. In some implementations, the processing circuitry of the server 106 applies one or more machine learning algorithms to update the shopper profile based on the feedback provided by the shopper at the shopper feedback screen 1400. For example, if the shopper profile indicates that the shopper prefers casual attire and the shopper provides feedback indicating a high level of satisfaction with an article of formal attire, the processing circuitry of the server 106 updates the shopper style profile based on the feedback.

The remote shopping system 100 allows shoppers to virtually try on articles of clothing so that the shoppers can make informed decisions about clothing purchases when shopping online. The shoppers are able to see the articles of clothing displayed on the shopper avatar that has proportional dimensions to the body measurements of the shopper. In addition, the remote shopping system 100 suggests articles of clothing to the shopper based on size, budget, and style to reduce the amount of time the shopper spends searching for clothing. The remote shopping system 100 allows shoppers to make confident decisions about their online clothing purchases.

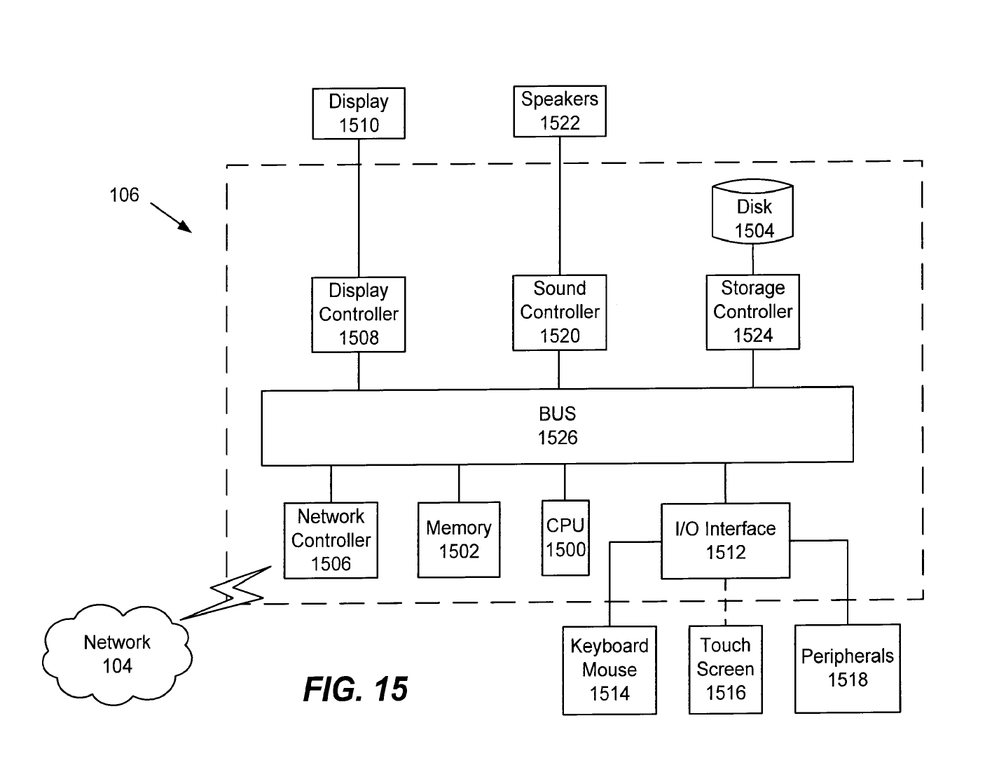

A hardware description of server 106 according to exemplary embodiments is described with reference to FIG. 15. In addition, the hardware described by FIG. 15 can also apply to the computer 110 and the mobile device 112. Implementation of the processes of the remote shopping system 100 on the hardware described herein improves the speed and accuracy of developing shopper profiles, generating shopper avatars, selecting clothing for shoppers to virtually try on, and receiving feedback regarding the one or more clothing selections. The server 106 includes a CPU 1500 that perform the processes described herein. The process data and instructions may be stored in memory 1502. These processes and instructions may also be stored on a storage medium disk 1504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server 106 communicates, such as the computer 110.

Further, the claimed advancements may be provided as a utility application, background daemon, or component of an operating system, or combination thereof, executing in conjunction with CPU 1500 and an operating system such as Microsoft Windows 7, UNIX, Solaris, LINUX, Apple MAC-OS and other systems known to those skilled in the art.

CPU 1500 may be a Xenon or Core processor from Intel of America or an Opteron processor from AMD of America, or may be other processor types that would be recognized by one of ordinary skill in the art. Alternatively, the CPU 1500 may be implemented on an FPGA, ASIC, PLD or using discrete logic circuits, as one of ordinary skill in the art would recognize. Further, CPU 1500 may be implemented as multiple processors cooperatively working in parallel to perform the instructions of the inventive processes described above.

The server 106 in FIG. 15 also includes a network controller 1506, such as an Intel Ethernet PRO network interface card from Intel Corporation of America, for interfacing with network 104. As can be appreciated, the network 104 can be a public network, such as the Internet, or a private network such as an LAN or WAN network, or any combination thereof and can also include PSTN or ISDN sub-networks. The network 104 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The server 106 further includes a display controller 1508, such as a NVIDIA GeForce GTX or Quadro graphics adaptor from NVIDIA Corporation of America for interfacing with display 1510 of the server 106 and the computer 110, such as a Hewlett Packard HPL2445w LCD monitor. A general purpose I/O interface 1512 at the server 106 interfaces with a keyboard and/or mouse 1514 as well as a touch screen panel 1516 on or separate from display 1510. General purpose I/O interface 1512 also connects to a variety of peripherals 1518 including printers and scanners, such as an OfficeJet or DeskJet from Hewlett Packard.

A sound controller 1520 is also provided in the server 106, such as Sound Blaster X-Fi Titanium from Creative, to interface with speakers/microphone 1522 thereby providing sounds and/or music.

The general purpose storage controller 1524 connects the storage medium disk 1504 with communication bus 1526, which may be an ISA, EISA, VESA, PCI, or similar, for interconnecting all of the components of the server 106. A description of the general features and functionality of the display 1510, keyboard and/or mouse 1514, as well as the display controller 1508, storage controller 1524, network controller 1506, sound controller 1520, and general purpose I/O interface 1512 is omitted herein for brevity as these features are known.

In other alternate embodiments, processing features according to the present disclosure may be implemented and commercialized as hardware, a software solution, or a combination thereof. Moreover, instructions corresponding to the remote shopping process 200 in accordance with the present disclosure could be stored in a thumb drive that hosts a secure process.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, an implementation may be performed on modules or hardware not identical to those described. Accordingly, other implementations are within the scope that may be claimed.

1. A remote shopping system comprising:
at least one server having circuitry configured to
receive one or more body measurements corresponding to one or more dimensions of a body of a user,
receive at least one body image of the user,
process the at least one body image of the user to determine one or more additional body measurements,
generate a shopper avatar having proportional dimensions to the one or more body measurements,
determine shopper clothing sizes based on the one or more body measurements corresponding to one or more size charts,
determine a clothing budget including one or more budget subcategories associated with one or more types of clothing,
determine one or more style preferences based on at least one of style, store, and brand inputs from at least one external device,
establish a shopper profile including at least one of the clothing sizes, the one or more style preferences, and the clothing budget,
output one or more suggested articles of clothing to the at least one external device based on the shopper profile,
receive one or more clothing selections via the at least one external device, and
receive shopper feedback related to the one or more clothing selections.

2. The system of claim 1, wherein the circuitry is further configured to determine that the clothing budget has been exceeded based on the one or more clothing selections.

3. The system of claim 1, wherein the one or more body measurements include at least one of neck, chest, bust, base of sleeve, ribcage, elbow, waist, wrist, upper hips, hips, thigh, knee, and ankle measurements.

4. The system of claim 3, wherein the circuitry is further configured to
perform edge detection processing to detect edges of a body in the at least one body image, and
determine the one or more additional body measurements based on distances between the edges of the body in the at least one body image.

5. The system of claim 1, wherein the shopper clothing sizes include at least one of shirt, pants, dress, and skirt sizes.

6. The system of claim 1, wherein the circuitry is further configured to determine one or more style preferences based on content linked to one or more social media accounts.

7. The system of claim 1, wherein the circuitry is further configured to output the shopper avatar wearing the one or more clothing selections.

8. The system of claim 7, wherein the circuitry is further configured to determine one or more body locations where the one or more clothing selections do not fit the body of the user.

9. The system of claim 7, wherein the circuitry is further configured to output notification messages to the at least one external device displaying the shopper avatar wearing one or more promoted articles of clothing.

10. The system of claim 1, wherein the circuitry is further configured to determine the clothing budget based on a predetermined percentage of a monthly income.

11. The system of claim 1, wherein the circuitry is further configured to determine the one or more budget subcategories based on a time of year.

12. The system of claim 1, wherein the circuitry is further configured to determine that the one or more suggested articles of clothing are available in stores in the shopper clothing sizes.

13. The system of claim 1, wherein the circuitry is further configured to output a warning when sizes of the one or more clothing selections do not correspond to the shopper clothing sizes.

14. The system of claim 13, wherein the circuitry is further configured to output a warning when styles of the one or more clothing selections do not match the one or more style preferences.

15. The system of claim 1, wherein the circuitry is further configured to update the shopper profile based on the shopper feedback using one or more machine learning algorithms.

16. The system of claim 15, wherein the shopper feedback includes at least one of a fit rating, a style rating, and a cost value rating.

17. The system of claim 16, wherein the fit rating includes one or more body locations where the one or more clothing selections fit too tightly or too loosely.

18. The system of claim 17, wherein the circuitry is further configured to request additional information via the at least one external device when the shopper feedback is outside a predetermined threshold.

19. A method for remote shopping comprising:
receiving, via at least one external device, one or more body measurements corresponding to one or more dimensions of a body of a user,
receiving, via the at least one external device, at least one body image of the user,
processing, at at least one server, the at least one body image of the user to determine one or more additional body measurements,
generating, at the at least one server, a shopper avatar having proportional dimensions to the one or more body measurements,
determining, at the at least one server, shopper clothing sizes based on the one or more body measurements corresponding to one or more size charts,
determining, at the at least one server, a clothing budget including one or more budget subcategories associated with one or more types of clothing,
determining, at the at least one server, one or more style preferences based on at least one of style, store, and brand inputs from the at least one external device,
establishing, at the at least one server, a shopper profile including at least one of the clothing sizes, the one or more style preferences, and the clothing budget,
outputting, to the at least one external device, one or more suggested articles of clothing based on the shopper profile,
receiving, via the at least one external device, one or more clothing selections, and
receiving, via the at least one external device, shopper feedback related to the one or more clothing selections.

20. A non-transitory computer-readable medium having computer-readable instructions thereon which when executed by a computer cause the computer to perform a method for remote shopping, the method comprising:
receiving one or more body measurements corresponding to one or more dimensions of a body of a user,
receiving at least one body image of the user,
processing the at least one body image of the user to determine one or more additional body measurements,
generating a shopper avatar having proportional dimensions to the one or more body measurements,
determining shopper clothing sizes based on the one or more body measurements corresponding to one or more size charts,
determining a clothing budget including one or more budget subcategories associated with one or more types of clothing,
determining one or more style preferences based on at least one of style, store, and brand inputs from at least one external device,
establishing a shopper profile including at least one of the clothing sizes, the one or more style preferences, and the clothing budget,
outputting one or more suggested articles of clothing to the at least one external device based on the shopper profile,
receiving one or more clothing selections via the at least one external device, and
receiving shopper feedback related to the one or more clothing selections.
